(19) United States
(12) Patent Application Publication
(10) Pub. No.: US 2022/0366786 A1
(43) Pub. Date: Nov. 17, 2022

(54) METHOD AND APPARATUS FOR ESTIMATING LANE PAVEMENT CONDITIONS BASED ON STREET PARKING INFORMATION

(71) Applicant: HERE Global B.V., Eindhoven (NL)

(72) Inventors: Leon STENNETH, Chicago, IL (US); Jerome BEAUREPAIRE, Berlin (DE); Jeremy YOUNG, Chicago, IL (US)

(21) Appl. No.: 17/306,531

(22) Filed: May 3, 2021

(51) Int. Cl. G08G 1/0967; G08G 1/14; G08G 1/01; G01C 21/34; G01C 21/30

(52) U.S. Cl. CPC G08G 1/096725; G08G 1/147; G08G 1/0129; G01C 21/3415; G01C 21/30; G06K 9/6256

(57) ABSTRACT

An approach is provided for estimating lane pavement conditions based on street parking events. For example, the approach involves map-matching a vehicle park-in event, a vehicle park-out event, or a combination thereof to a lane of a road segment. The approach also involves calculating an adjusted pavement condition of the lane based on the map matched park-in event, the map-matched park-out event, or a combination thereof, wherein the adjusted pavement condition accounts for a reduction of a weather effect on a pavement condition of the lane caused by one or more vehicles parking in the lane. The approach further involves providing the adjusted pavement condition of the lane as an output.

### BACKGROUND

Weather has significant impacts on driving conditions and safety. For instance, rain can cause slippery road surfaces, and snow can paralyze traffic flow. Weather service providers (e.g., governmental providers, commercial providers, crowd-sourced providers, etc.) distribute weather related data to users directly or a part of traffic reporting services. The weather related data come from various sources, including crowd-souring from vehicles. For example, modern vehicles are capable of sensing and reporting road-related events such as slippery road reports as they travel throughout a road network. However, there are other ways vehicles or other objects nearby a road segment can interact with weather and affect driving conditions and safety, beside sensing and reporting. Accordingly, service providers face significant technical challenges to look into new interactions between vehicles and weather that impact driving conditions and safety.

### Some Example Embodiments

Therefore, there is need for an approach for determining effects of interactions between weather and vehicles that affect driving conditions and safety, such as affecting lane pavement conditions based on street parking events.

According to one embodiment, a computer-implemented method comprises map-matching a vehicle park-in event, a vehicle park-out event, or a combination thereof to a lane of a road segment. The method also comprises calculating an adjusted pavement condition of the lane based on the map matched park-in event, the map-matched park-out event, or a combination thereof. The adjusted pavement condition accounts for a reduction of a weather effect on a pavement condition of the lane caused by one or more vehicles parking in the lane. The method further comprises providing the adjusted pavement condition of the lane as an output.

According to another embodiment, an apparatus comprises at least one processor, and at least one memory including computer program code for one or more programs, the at least one memory and the computer program code configured to, with the at least one processor, to cause, at least in part, the apparatus to map-match a vehicle park-in event, a vehicle park-out event, or a combination thereof to a lane of a road segment. The apparatus is also caused to calculate an adjusted pavement condition of the lane based on the map matched park-in event, the map-matched park-out event, or a combination thereof. The adjusted pavement condition accounts for a reduction of a weather effect on a pavement condition of the lane caused by one or more vehicles parking in the lane. The apparatus is further caused to provide the adjusted pavement condition of the lane as an output.

According to another embodiment, a computer-readable storage medium carrying one or more sequences of one or more instructions which, when executed by one or more processors, cause, at least in part, an apparatus to map-match a vehicle park-in event, a vehicle park-out event, or a combination thereof to a lane of a road segment. The apparatus is also caused to calculate an adjusted pavement condition of the lane based on the map matched park-in event, the map-matched park-out event, or a combination thereof. The adjusted pavement condition accounts for a reduction of a weather effect on a pavement condition of the lane caused by one or more vehicles parking in the lane. The apparatus is further caused to provide the adjusted pavement condition of the lane as an output.

According to another embodiment, an apparatus comprises means for map-matching a vehicle park-in event, a vehicle park-out event, or a combination thereof to a lane of a road segment. The apparatus also comprises means for calculating an adjusted pavement condition of the lane based on the map matched park-in event, the map-matched park-out event, or a combination thereof. The adjusted pavement condition accounts for a reduction of a weather effect on a pavement condition of the lane caused by one or more vehicles parking in the lane. The apparatus further comprises means for providing the adjusted pavement condition of the lane as an output.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of estimating lane pavement conditions based on street parking events, according to one embodiment;

FIG. 2A is a diagram illustrating an example lane pavement scenario affected by street parking events, according to one embodiment;

FIG. 2B are diagrams illustrating example lane pavement scenario affected by street parking events and/or objects, according to various embodiments;

FIG. 2C is a diagram of an example machine learning data matrix, according to one embodiment;

FIG. 3 is a diagram of the components of a mapping platform capable of estimating lane pavement conditions based on street parking events, according to one embodiment;

FIG. 4 is a flowchart of a process for estimating lane pavement conditions based on street parking events, according to one embodiment;

FIGS. 5A-5C are diagrams of example map user interfaces associated with estimating lane pavement conditions based on street parking events, according to various embodiments;

FIG. 6 is a diagram of a geographic database, according to one embodiment;

FIG. 7 is a diagram of hardware that can be used to implement an embodiment of the invention, according to one embodiment;

FIG. 8 is a diagram of a chip set that can be used to implement an embodiment of the invention, according to one embodiment; and

FIG. 9 is a diagram of a mobile terminal (e.g., handset or vehicle or part thereof) that can be used to implement an embodiment.

### DESCRIPTION OF SOME EMBODIMENTS

Examples of a method, apparatus, and computer program for estimating lane pavement conditions based on street parking events are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

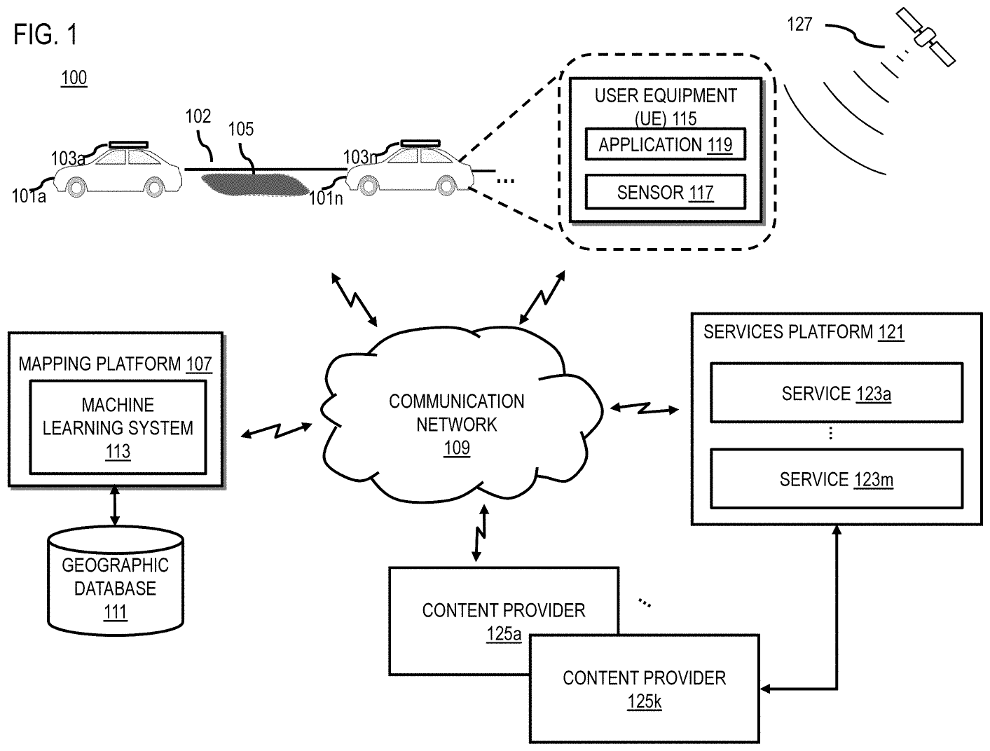

FIG. 1 is a diagram of a system capable of estimating lane pavement conditions based on street parking events, according to one embodiment. Service providers and vehicle manufacturers are increasingly developing compelling navigation and other location-based services that improve the overall driving experience and safety by leveraging vehicle capabilities, such as autonomous driving, reporting road events using sensor data collected by connected vehicles as they travel, etc. For example, the vehicles can use their respective sensors to detect slippery road conditions (e.g., loss of adhesion between the vehicle and the road on which it is traveling), which in turn can be used for issuing local hazard warning, updating real-time mapping data, as inputs to a mapping database.

Weather events such as precipitation, high winds, extreme temperatures, etc. can affect driver capabilities (e.g., visibilities), vehicle performance (i.e., traction, stability and maneuverability), pavement friction, roadway infrastructure, crash risk, traffic flow, etc. There are many methods for estimating pavement conditions based on different weather events, using inputs such as snowplow locations, solar radiation, precipitation intensity, precipitation type, soil percolation rates, etc. However, none of the methods consider street parking events and their impacts on the pavement conditions at a lane-level.

To address these problems, the system 100 of FIG. 1 introduces a capability to estimate lane pavement conditions based on street parking events. In one embodiment, the system 100 can provide a lane level model that takes on-street parking information (e.g., parking and de-parking information about on-street parking spots) into consideration when estimating pavement conditions.

As shown FIG. 1, the system 100 comprises one or more vehicles 101a-101n (also collectively referred to as vehicles 101) respectively equipped with sensors 103a-103n (also collectively referred to as sensors 103) for sensing vehicle street parking events, and/or other characteristics (e.g., slippery road conditions) on a road segment 102 of a transportation network (e.g., a road network) in which the vehicles 101 are traveling. For example, the system 100 can determine a vehicle park-in/park-out event at a parked location (e.g., a parked location 105) on the on the road segment 102 within a parking time frame (that overlapped with a weather/snow event) based on location sensor data of a vehicle 101 and street-parking area data (e.g., via map-matching based on map data). The location sensors can apply various positioning assisted navigation technologies, e.g., global navigation satellite systems (GNSS), WiFi, Bluetooth, Bluetooth low energy, 2/3/4/5/6G cellular signals, ultra-wideband (UWB) signals, etc., and various combinations of the technologies to derive vehicle location data.

In another embodiment, the system 100 can collect data from one or more onboard vehicle sensors that detect and report in when the vehicle 101 is parked, reversed, and/or driven, to determine a vehicle park-in/park-out event and a parked location/time frame.

In yet another embodiment, the system 100 can collect data from one or more infrastructure sensors, such as ultrasonic sensors installed in the pavement, to determine a vehicle park-in/park-out event and a parked location/time frame. For example, San Francisco has a SFpark system (www.sfpark.org) for monitoring on and off-street parking via sensors placed in the asphalt.

In yet another embodiment, the system 100 can query data from parking databases, such as INRIX®, Parkopedia®, etc., that provide estimated parking availability (e.g., a likelihood/probability) for a road link during a time period. A reply of no availability means that the time-restricted parking lane of the road link is fully parked with vehicles, hence the time-restricted parking lane(s) of the road link is covered from a weather condition (e.g., snow, rain, etc.). The system 100 may not require absolute certainty of a snow-free parked lane, but with a probability passing a threshold.

With the parked location/time frame data, the system 100 can estimate a pavement condition of the parked location considering weather condition(s) during the parked time frame and a delta/difference Δ contributed by parked vehicle(s), since the parked vehicle(s) functioned as a weather shelter for the parked location during the parked time frame. For instance, a lane with more parked locations/spots during snow or heavy rain for a time period can be more drivable (e.g., with less chances of snowy or slippery condition) than the snow/rain-covered lane(s), after the vehicle(s) left.

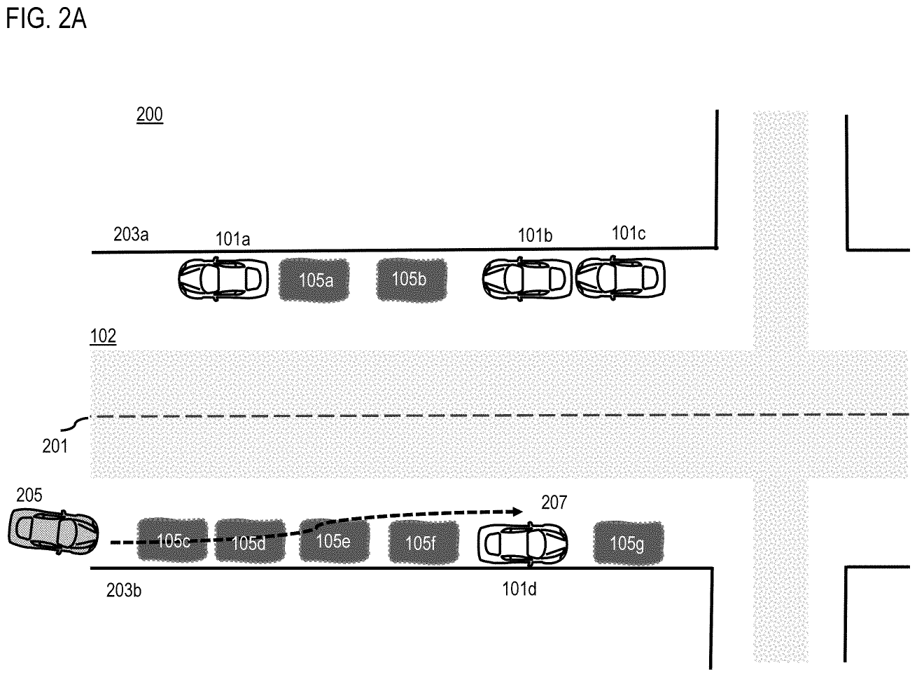

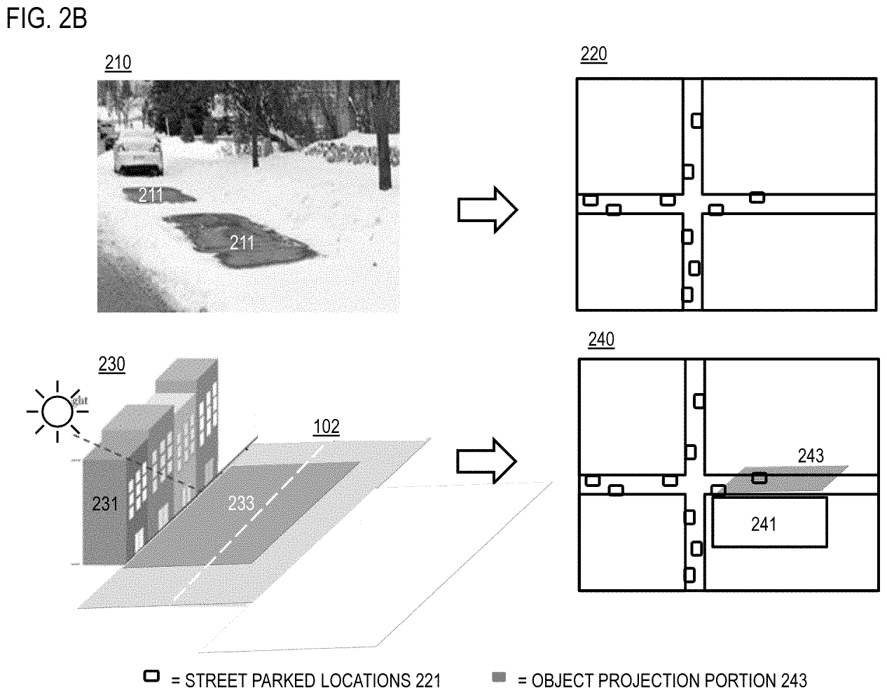

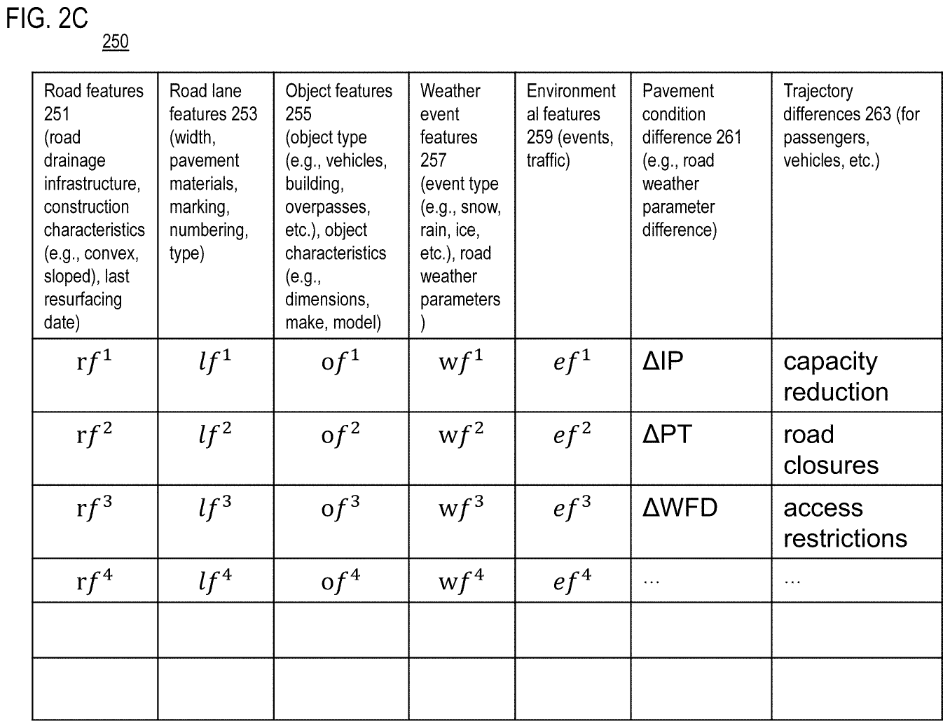

The system 100 can take advantage of a road segment with time-restricted parking lane(s), where vehicles are free to park during a time frame and free to drive via during another time frame. For instance, the restricted parking lanes are parked with vehicles at the time of a weather event (e.g., snow, rain, etc.), thereby leaving e.g., a snow/rain free or dry lane for vehicles to drive via. FIG. 2A is a diagram 200 illustrating an example lane pavement scenario affected by street parking events, according to one embodiment. In FIG. 2A, the road segment 102 with time-restricted parking lanes on both sides is covered with snow and only portions neat its center line 201 has been partially plowed. On a curb 203a side of the road segment 102, there are two parked/snow-free locations 105a, 105b between three parked vehicles 101a, 101b, 101c. On a curb 203b side of the road segment 102, there are five parked/snow-free locations 105c-105g and only one parked vehicle 101d. In this scenario, the system 100 can navigate/direct an incoming vehicle 205 to drive via the parked/snow-free locations 105c-105f along a path 207, to improve safety and speed.

FIG. 2B are diagrams illustrating example lane pavement scenario affected by street parking events and/or objects, according to various embodiments. FIG. 2B shows a street image 210 depicting street parking events during snow that left two snow-free parked locations 211. In this embodiment, the system 100 can convert the snow-free parked locations 211 in the street image 210 into street parked locations 221 in a diagram 220 using computer vision and/or the positioning methods described in conjunction with FIG. 2A.

In addition to or in place of parked vehicle(s), the system 100 can consider other objects (e.g., buildings, overpasses, etc.) nearby the road segment 102 with weather effect(s) to calculate a delta/difference Δ contributed by such object(s) under weather condition(s) during a time frame. For instance, FIG. 2B shows a street diagram 230 depicting building(s) 231 that can block a portion of a road segment from snow/rain similar to a parked vehicle thus reducing the weather effect. As another instance, the building(s) 231 can block a portion 233 (e.g., snow/rain-covered) of the road segment 102 from sunlight thus increasing the weather effect. The system 100 can determine the portion 233 using map data (e.g., including three-dimensional (3D) model data of the building(s)), weather data (e.g., sun direction, strength, etc.), and 3D projection. In this embodiment, the system 100 can convert the building(s) 231 and the portion 233 in the street diagram 230 into building(s) 241 and an object-projection portion 243 in a diagram 240 using 3D-2D conversion and/or the positioning methods described in conjunction with FIG. 2A.

In addition to snow, rain, sun, the system 100 can apply the about-discussed embodiments to other weather events such as sleet, slush, ice, fog, etc. that can impact pavement conditions. More than 20% of car crashes are weather-related, i.e., that occur in adverse weather (i.e., rain, sleet, snow, fog, severe crosswinds, and/or blowing snow/sand/debris) and/or on slick pavements (i.e., wet pavements, snowy/slushy pavements, or icy pavements). The majority of weather-related crashes happen on wet pavement and during rainfall. A smaller percentage of weather-related crashes occur during winter conditions: during snow or sleet, occur on icy pavement, and on snowy or slushy pavement. Only a small percentage happen in the presence of fog.

In one embodiment, the system 100 can quantify these weather events using road weather parameters such as air temperature and humidity, wind speed, precipitation (type, rate, start/end times), pavement temperature, pavement condition, water film depth, etc., and calculate a delta/difference Δ of one or more of the road weather parameter(s) contributed by parked vehicle(s) and/or object(s) under weather event(s) during a time frame.

For instance, wind speed can cause lane obstruction (e.g., due to wind-blown snow, debris, etc.), pavement dryness (e.g., due to wind-blown away surface water), etc. As another instance, precipitation can impact pavement friction, lane obstruction, etc. A pavement temperature can affect speeds of snow melting, water drying, etc. A pavement condition may affect pavement friction, water/snow retention, etc. A water film depth can cause lane submersion, affect a speed of drying, etc.

Referring back to the diagram 240 of FIG. 2B, the system 100 can calculate a snow built-up difference Δsnow (e.g., of a pavement condition) between the street parked locations 221 and the rest of the snow-covered road segment, immediately after the snowfall. Concurrently or alternatively, the system 100 can consider a snow built-up difference Δwind attributed to building(s) interaction with the wind speed parameter (e.g., blocking snow from building up within the object projection portion 243), such that the adjusted pavement condition between the street parked locations 221 and the remaining object projection portion 243 is Δsnow−Δwind. Concurrently or alternatively, the system 100 can further consider a snow melting difference Δsun attributed to building(s) interaction with the sun parameter (e.g., blocking snow from reaching the object projection portion 243), such that the adjusted pavement condition between the street parked locations 221 and the remaining object projection portion 243 is refined to Δsnow−Δwind+Δsun.

In one embodiment, the system 100 can collect weather data via sensors 103 of the vehicle 101 and/or other sources (e.g., weather database(s) of private and/or public entities), analyze the weather data for pavement condition difference data per road lane, and store the pavement condition difference data in a database (e.g., a geographic database). In addition, the sensors 103 of the vehicle 101 can report parked location data to a mapping platform 107 via a communication network 109. The mapping platform 107 can generate an optimal route for a coming vehicle 101 to minimize weather effects) based on pavement condition difference data from the database (e.g., a geographic database 111), and alert/prepare passenger(s), for example, for potential slippery/snowy road event(s) en route based on the pavement condition difference data, etc. By way of example, the optimal route can be determined by any navigation routing engine known in the art to pass via parked locations as shown in FIG. 2A.

In one embodiment, the mapping platform 107 can include a machine learning system 113 for analyzing weather data and parking/object data, and extract pavement condition difference data associated with road lanes. The extracted data can be stored in a database (e.g., the geographic database 111).

FIG. 2C is a diagram of an example machine learning data matrix, according to one embodiment. In one embodiment, the matrix/table 250 can further include input features such as road link/segment feature(s) 251 (e.g., road drainage infrastructure, construction characteristics (e.g., convex, sloped, flat, etc.), last resurfacing date, built by contractor X, etc.), road lane feature(s) 253 (e.g., width, pavement materials (e.g., concrete, asphalt, stone, etc.), marking, numbering, type (e.g., parking, traffic, through, auxiliary, express, reversible, dedicated, fire, loading, overtaking, slow, etc.), object feature(s) 255 (e.g., object type (e.g., vehicles, building, overpasses, etc.), object characteristics (e.g., dimensions, make, model, etc.), etc.), weather event features 257 (e.g., event type (e.g., snow, rain, ice, etc.), road weather parameters (e.g., such as intensity of precipitation (IP), pavement temperature (PT), water film depth (WFD), etc.), environment features 259 (e.g., events, traffic, traffic light status, construction status, etc.), in order to generate output features such as pavement condition difference(s) for different lanes (e.g., weather parameter difference(s), such as ΔIP, ΔPT, ΔWFD, etc.) 261, and trajectory difference(s) (for passengers, vehicles, etc.) (e.g., capacity reduction, road closures, access restrictions, etc.) 263. For instance, capacity reductions can be caused by lane submersion due to flooding and by lane obstruction due to snow accumulation and wind-blown debris. Road closures and access restrictions due to hazardous conditions (e.g., large trucks in high winds) also decrease roadway capacity.

By way of example, the matrix/table 250 can list relationships among features and training data. For instance, notation [symbol] rf [symbol] \hat{ }i can indicate the ith set of road features, [symbol] lf [symbol] \hat{ }i can indicate the ith set of road lane features, of [symbol] of [symbol] \hat{ }i can indicate the ith set of object features, [symbol] wf [symbol] \hat{ }i can indicate the ith set of weather events, [symbol] ef [symbol] \hat{ }i can indicate the ith set of environmental features, etc.

In one embodiment, the training data can include ground truth data taken from historical pavement condition data and/or historical pavement condition difference data. For instance, the ground truth data can be taken via visual inspection, pavement inspection units, field sensors, etc. A pavement inspection unit can be as big as 15-60 m long by one to four lanes wide (e.g., mounted on a vehicle), installed in a roadway, or a compact as a hand-held device.

By way of example, in-pavement surface temperature and condition sensors can be installed in roadways to detect real-time pavement temperature and conditions (e.g., dry, wet, ice-watch, chemically wet, etc.). As another example, rain gauges and precipitation sensors are widely deployed to detect precipitation types (e.g., liquid phase: rain and drizzle and dew, solid phase: snow, ice crystals, ice pellets (sleet), hail, and graupel, transition between liquid/solid phases), amount of precipitation, precipitation intensity, etc. The respective precipitation intensities can be classified by rate of fall, by visibility restriction, etc. As yet another example, a water measurement unit/sensor can measure water film depth to accuracy of one-tenth of millimeter, by contacting with the water film of the road such that an electric circuit is closed and an LED sign is shining.

In another embodiment, the vehicles 101 can be equipped with pavement inspection unit(s) and/or sensor(s) to detect road conditions (e.g., slippery/parked road conditions), environmental conditions (e.g., weather, lighting, etc.), vehicle telemetry data (e.g., speed, heading, acceleration, lateral acceleration, braking force, wheel speed, etc.), and/or other characteristics, to facilitate above-discussed embodiments. By way of example, there are real-time infrared road surface temperature measuring units/sensors to be mounted and/or built-in the vehicles 101, that can detect a one-degree change in road surface temperature in one-tenth of a second.

In one embodiment, in a data mining process, features are mapped to ground truth pavement condition difference(s) caused by weather event(s) and the presence of object(s) such as parked vehicles, buildings, overpasses, etc. to form a training instance. A plurality of training instances can form the training data for a machine learning model for determine pavement condition and/or pavement condition differences using one or more machine learning algorithms, such as random forest, decision trees, etc. For instance, the training data can be split into a training set and a test set, e.g., at a ratio of 25%:30%. After evaluating several machine learning models based on the training set and the test set, the machine learning model that produces the highest classification accuracy in training and testing can be used as the machine learning model for determining pavement conditions and/or pavement condition differences. In addition, feature selection techniques, such as chi-squared statistic, information gain, gini index, etc., can be used to determine the highest ranked features from the set based on the feature's contribution to classification effectiveness.

In other embodiments, ground truth pavement condition difference data can be more specialized than what is prescribed in the matrix/table 250. In the absence of one or more sets of the features 251-259, the model can still make a prediction using the available features.

In one embodiment, the pavement condition/difference machine learning model can learn from one or more feedback loops. For example, when a pavement condition difference is computed/estimated to be very high on a road lane yet no vehicles routed via parked locations (e.g., due to the implementation of the process 400), the pavement condition/difference machine learning model can learn from the feedback data, via analyzing and reflecting how the high pavement condition difference was generated. The pavement condition/difference machine learning model can learn the cause(s), for example, based on the vehicle model, the building dimensions, etc., and include new features into the model based on this learning. Alternatively, the pavement condition/difference machine learning model can blacklist the lane(s) where the computed pavement condition difference is high but no vehicles drove on the lane(s).

By analogy, a trajectory machine learning model that can determine the trajectory differences 263 and route the passenger(s) and/or the vehicle 101 prior to or during the road segment, based on the pavement condition/difference data, and the trajectory machine learning model can be trained in a similar way. In one embodiment, the machine learning system 113 selects respective features 251-261 determine the optimal trajectory differences 263 (e.g., capacity reduction, road closures, access restrictions, etc.), and then determine an optimal action(s) (e.g., route(s), lane(s), etc.) to be taken by the passenger(s), vehicle 101, etc. By way of example, the optimal actions can include lane change, route change, speed change, activity change, seat position/angle change, safety-belt tension change, close/open window, airbag activation, etc.

In other embodiments, the machine learning system 113 can train the pavement condition/difference machine learning model and/or the trajectory machine learning model to select or assign respective weights, correlations, relationships, etc. among the features 251-263, to determine optimal action(s) to take for different pavement condition difference scenarios on different road links/lanes. In one instance, the machine learning system 113 can continuously provide and/or update the machine learning models (e.g., a support vector machine (SVM), neural network, decision tree, etc.) during training using, for instance, supervised deep convolution networks or equivalents. In other words, the machine learning system 113 trains the machine learning models using the respective weights of the features to most efficiently select optimal action(s) to take for different pavement condition difference scenarios on different road links.

In another embodiment, the machine learning system 113 of the mapping platform 107 includes a neural network or other machine learning system(s) to update enhanced features on roads/lanes. In one embodiment, the neural network of the machine learning system 113 is a traditional convolutional neural network which consists of multiple layers of collections of one or more neurons (which are configured to process a portion of an input data). In one embodiment, the machine learning system 113 also has connectivity or access over the communication network 109 to the geographic database 111 that can each store map data, weather data, the feature data, the training data, etc.

In one embodiment, the machine learning system 113 can improve the machine learning models using feedback loops based on, for example, vehicle behavior data and/or feedback data (e.g., from passengers). In one embodiment, the machine learning system 113 can improve the machine learning models using the vehicle behavior data and/or feedback data as training data. For example, the machine learning system 113 can analyze correctly identified pavement condition difference data, trajectory data, and/or action data, missed pavement condition difference data, trajectory data, and/or action data, etc. to determine the performance of the machine learning models.

In another embodiment, the system 100 can build a machine learning model only one of the road weather parameters. Alternatively, the system 100 can apply the pavement condition/difference machine learning model to only one of the road weather parameters. By way of example, when the intensity of precipitation (IP) units is in mm/hr and reported for the road segment as IP, the system 100 can use the pavement condition/difference machine learning model to determine a parked lane based on parking data from one or more parking databases, map-match the parked locations to street map data (e.g., from the geographic database 111), reduce the IP by deltaIP (ΔIP) which is a configurable parameter that accounts for the fact that the lane(s) with parked vehicle(s) will have a lower number of mm/hr of snow/rain reaching the pavement.

As another example, when pavement temperature (PT) reported for the road segment as PT, the system 100 can use the pavement condition/difference machine learning model to a parked lane based on parking data from one or more parking databases, map-match the parked locations to street map data (e.g., from the geographic database 111), increase the PT by deltaPT (ΔPT) which is a configurable parameter that accounts for the fact that the lanes with parked vehicle(s) will have a higher pavement temperature than the rest of the road segment.

As yet another example, when water film depth (WFD) reported for the road segment as WFD, the system 100 can use the pavement condition/difference machine learning model to a parked lane based on parking data from one or more parking databases, map-match the parked locations to street map data (e.g., from the geographic database 111), reduce WFD by deltaWFD (ΔWFD) which is a configurable parameter that accounts for the fact that the lanes with parked vehicle(s) will have a different water film depth that lanes with no parked vehicles. For example, some lanes with parked vehicle(s) can have higher WFD due to fact that it is by the curb. The system 100 to determine if a curb is present based on the street map data. For another example, lanes with parked vehicle(s) can have a lower WFD due to the fact that is closer to drainage, based on the street map data. By way of example, after heavy rain, while the rest of the road segment will be reported as wet, street parked locations/spaces can be damp and hence have a different pavement condition (e.g., a different coefficient of friction).

The difference/delta parameters (e.g., ΔIP, ΔPT, ΔWFD, etc.) are adjustment factors to account for parked locations on the lane/road. They can be directly determined based on historical pavement condition difference data. Alternatively, the difference/delta parameters (e.g., ΔIP, ΔPT, ΔWFD, etc.) can be predicted/estimated using the above-described machine learning models trained with the historical pavement condition difference data per lane/road. As discussed, individual machine learning models could be used for one road weather parameter, or a single machine learning model can handle multiple road weather parameters and produces one or more outputs of pavement condition differences contributed by the road weather parameters.

Given the predicted ΔIP, ΔPT, ΔWFD, etc., the system 100 can provide aggregated pavement condition(s) estimated for the lane parked with vehicle(s). By way of example, the pavement condition can be classified as dry, wet, packed snow, icy, slippery frost, black ice, etc. By way of example, the system 100 can recommend autonomous vehicles to drive over lanes/streets which have had such parking spaces occupied since they reduce the risk of slippery lanes/roads and vehicles would have less traction loss. These roads have parking lanes reserved to parking for certain time period(s) (e.g., from 21:00 till 7:00 AM) and can be driven during the day, especially when snow falls during the night.

As another example, the system 100 can provide a give-and-get model where vehicles that report their on-street parking/de-parking activities will be given the higher priority to use these parked lane(s) (e.g., higher traction lane(s)).

In another example, the system 100 can incentivize vehicles to go and park on some defined lanes during given timeframe(s) (e.g., overnight) to support driving safety after certain weather event(s) (e.g., rain/snow/ice). The system 100 can manage the go-and-park in a dynamic way based on the specificities of the weather event(s), relevant vehicle owners in given area(s) for a desired duration (associated with the weather event), incentives (e.g., free parking or other types), etc. Other incentives can include offers of alternative modes of transport (e.g., public transport, ride hailing/sharing, etc.) to reach planned destination(s) after parking, and from the planned destination(s) back to the parking location(s).

The above-discussed embodiments can be applied to increase travel safety in any roads/lanes including motorways, train tracks, airplane runways, etc. to send hazardous warnings (e.g., slippery/snowy/icy lanes/roads), and/or recommend actions to mitigate pavement condition impacts of weather events at a lane/road level, considering objects with weather effect, such as parked vehicles, building, overpasses, etc.

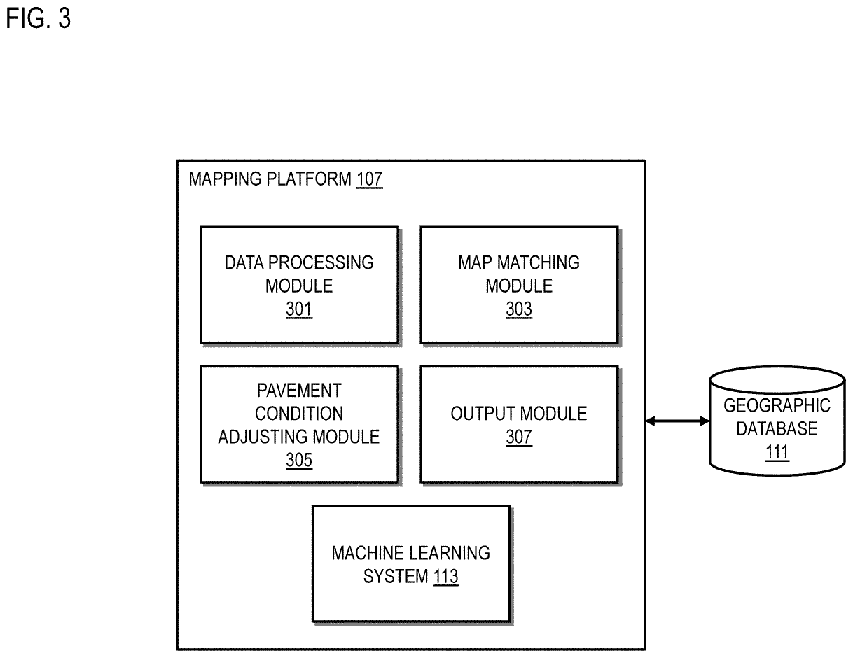

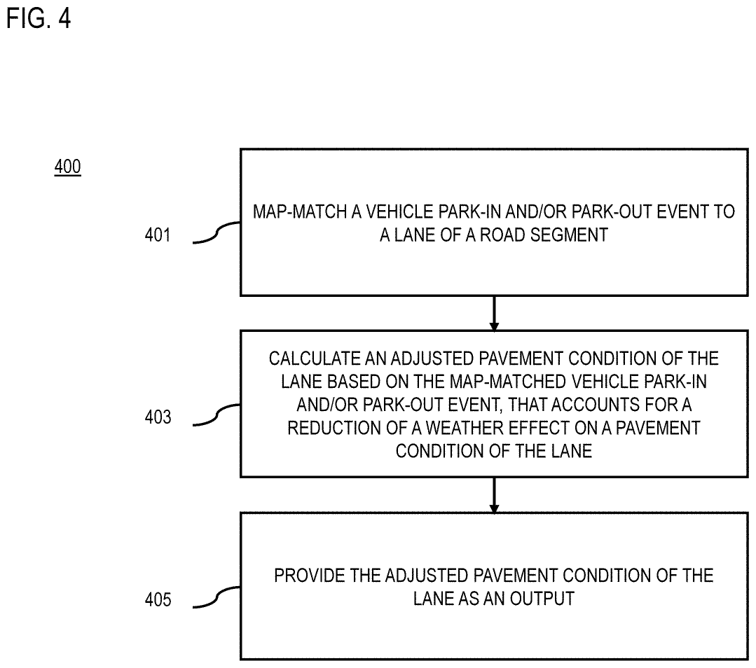

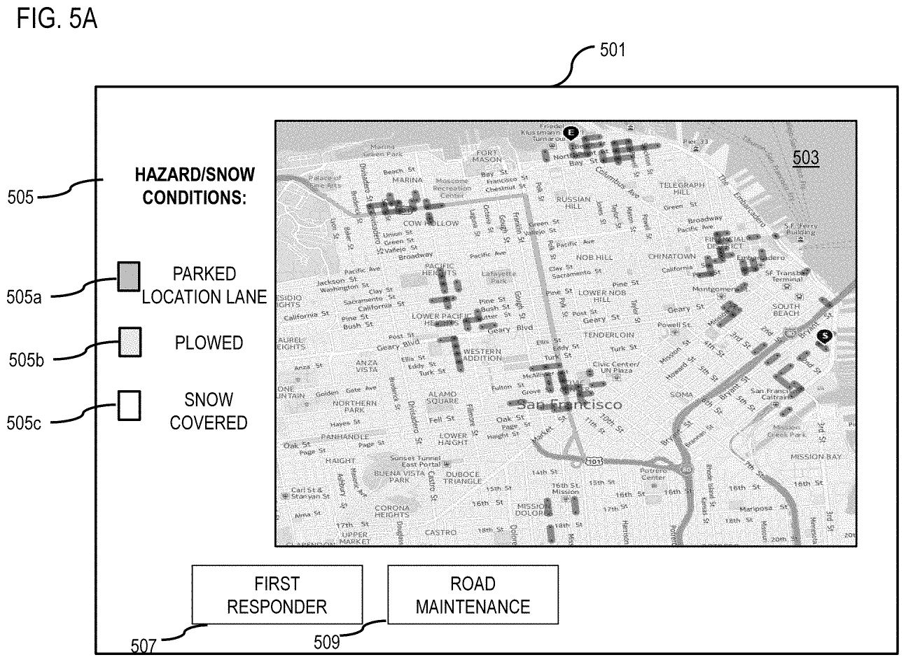

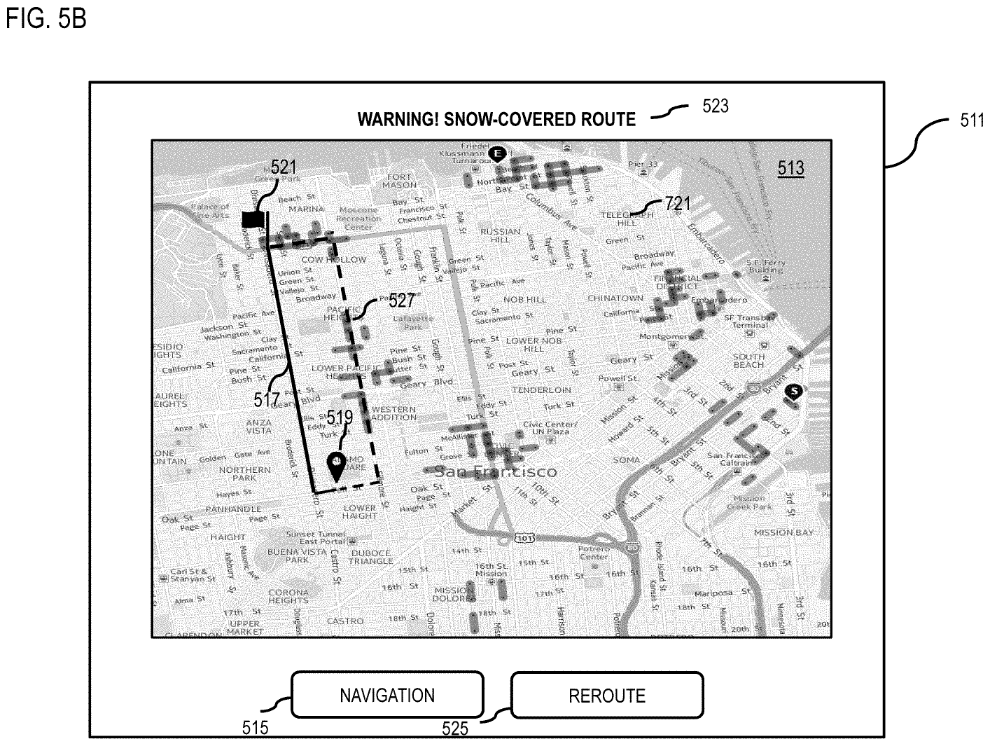

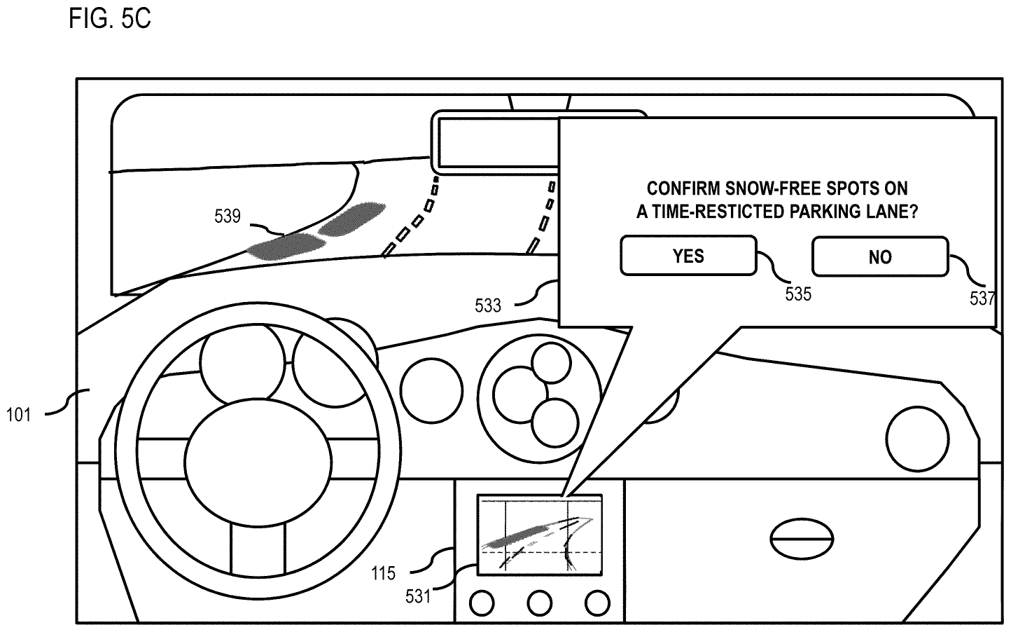

FIG. 3 is a diagram of the components of a mapping platform capable of estimating lane pavement conditions based on street parking events, according to one embodiment. By way of example, the mapping platform 107 includes one or more components for providing a confidence-based road event message according to the various embodiments described herein. It is contemplated that the functions of these components may be combined or performed by other components of equivalent functionality. In this embodiment, the mapping platform 107 includes data processing module 301, map matching module 303, pavement condition adjusting module 305, an output module 307, and the machine learning system 113. The above presented modules and components of the mapping platform 107 can be implemented in hardware, firmware, software, or a combination thereof. Though depicted as a separate entity in FIG. 1, it is contemplated that the mapping platform 107 may be implemented as a module of any of the components of the system 100 (e.g., a component of the vehicle 101, services platform 121, services 123, a client terminal, etc.). In another embodiment, one or more of the modules 301-307 and the machine learning system 113 may be implemented as a cloud based service, local service, native application, or combination thereof. The functions of the mapping platform 107, the modules 301-307, and the machine learning system 113 are discussed with respect to FIGS. 4-5 below.

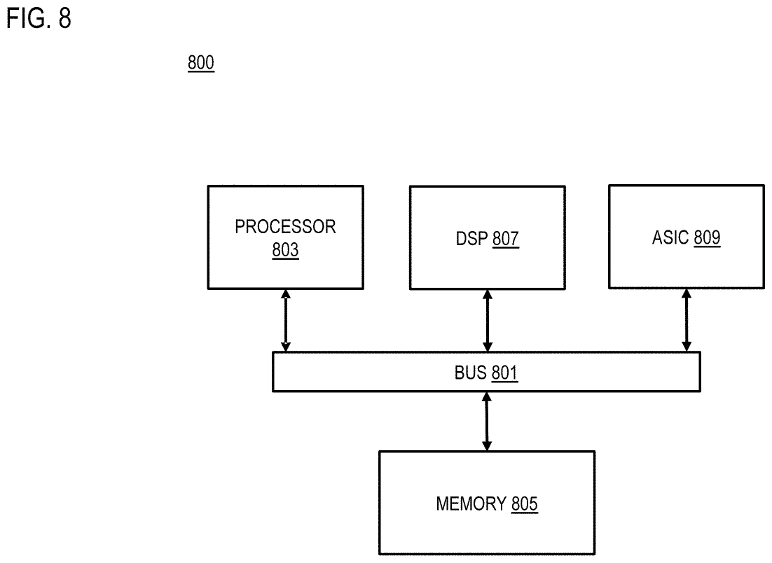

FIG. 4 is a flowchart of a process for estimating lane pavement conditions based on street parking events, according to one embodiment. In various embodiments, the mapping platform 107, the machine learning system 113, and/or any of the modules 301-307 may perform one or more portions of the process 400 and may be implemented in, for instance, a chip set including a processor and a memory as shown in FIG. 8. As such, the mapping platform 107, the machine learning system 113, and/or the modules 301-307 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In one embodiment, the data processing module 301 can retrieve weather data (e.g., from weather database(s) of private and/or public entities), pavement condition data (e.g., from road database(s) of private and/or public entities), map data (e.g., from one or more mapping services, map databases, the geographic database 111, etc.), and/or vehicle sensor data for later processing.

In one embodiment, a vehicle park-in event, a vehicle park-out event, or a combination thereof can be detected using one or more sensors (e.g., vehicle sensors 103). For instance, the vehicle sensor data can also include weather data and/or pavement condition data detected by sensors 103 (e.g., camera sensors, light sensors, LiDAR sensors, radar, infrared sensors, thermal sensors, etc.) of the vehicles 101 when travelling in a road network. In one embodiment, each vehicle 101 is configured to report weather data and/or pavement condition data as road-link map attributes, which are individual data records collected at a point in time when the vehicle 101 is travelling on the road link.

In another embodiment, the data processing module 301 can query data from parking databases, such as INRIX®, Parkopedia®, etc., that provide estimated parking availability (e.g., a likelihood/probability) for the road segment 102 during a weather condition (e.g., snow) time period. When the data processing module 301 receives a reply of no parking availability during the weather condition, for example a snowing time period, the data processing module 301 can determine that the time-restricted parking lane of the road segment 102 was fully parked with vehicles, hence eliminated from the snowing condition. The data processing module 301 may not require absolute certainty of a snow-free parked lane, but with a probability meeting a threshold.

In one embodiment, for example, in step 401, the map-matching module 303 can map-match the vehicle park-in event, the vehicle park-out event, or a combination thereof to a lane (e.g., a time-restricted parking lane) of a road segment. Referring back to the Example in FIG. 2A, the map-matching module 303 can determine a vehicle park-in/park-out event on the time-restricted parking lane on the road segment 102 within a parking time frame (that overlapped with a weather event, e.g. snow) by map-matching location sensor data of a vehicle 101 and street-parking area data (e.g., extracted from the map data).

Such time-restricted parking lane needs to have enough vehicles parked thereon at the time of a weather event (e.g., snow, rain, etc.), to leave continuous snow/rain free or dry spots for vehicles to drive via later. In this example, the road segment 102 has one time-restricted parking lane one each side reserved to parking for certain time period(s) (e.g., from 21:00 till 7:00 AM) and can be driven during the day, especially when snow falls during the night.

In one embodiment, in step 403, the pavement condition adjusting module 305 can calculate an adjusted pavement condition (e.g., Δsnow of the street parked locations 221 in the diagram 220 in FIG. 2B) of the lane (e.g., of the road segment 102) based on the map matched park-in event, the map-matched park-out event, or a combination thereof. The adjusted pavement condition (e.g., Δsnow) can account for a reduction of a weather effect (e.g., due to snowfall) on a pavement condition of the lane (e.g., snow accumulation) caused by one or more vehicles 101 parking in the lane. In the example of the street image 210 of FIG. 2B, the parked locations 221 have no or minimal snow accumulation thereon.

In other embodiments, the pavement condition adjusting module 305 can determine a delta value (e.g., ΔIP, ΔPT, ΔWFD, etc.) for the at least one road weather parameter based on a difference between a first value of a pavement surface of the lane with a vehicle parked over the pavement surface and a second value of the pavement surface without a vehicle parked over the pavement surface, and the adjusted pavement condition can be calculated based on the delta value (e.g., ΔIP, ΔPT, ΔWFD, etc.). By way of example, the at least one road weather parameter can be an intensity of precipitation (IP), a pavement temperature (PT), or a water film depth (WFD).

When the weather effect is the intensity of precipitation (IP), the adjusted pavement condition or the pavement condition can relate to a slippery road driving condition caused by the intensity of precipitation (e.g., of rain, snow, ice, sleet, hail, etc.). In this instance, the pavement condition adjusting module 305 can determine a delta parameter ΔIP for the intensity of precipitation based on a difference between a first amount of precipitation reaching a pavement surface of the lane with a vehicle parked over the pavement surface and a second amount of precipitation reaching the pavement surface without a vehicle parked over the pavement surface. The adjusted pavement condition can be calculated based on the delta parameter ΔIP.

When the adjusted pavement condition or the pavement condition relates to the pavement temperature (PT), the pavement condition adjusting module 305 can determine a delta parameter ΔPT for the pavement temperature based on a difference between a first pavement temperature of a pavement surface of the lane with a vehicle parked over the pavement surface and a second pavement temperature of the pavement surface without a vehicle parked over the pavement surface. The adjusted pavement condition is calculated based on the delta parameter ΔPT.

When the weather effect is the water film depth (WFD), the adjusted pavement condition or the pavement condition can relate to a slippery road driving condition caused by the intensity of precipitation. In this instance, the pavement condition adjusting module 305 can determine a delta parameter ΔWFD for the water film depth based on a difference between a first water film depth on a pavement surface of the lane with a vehicle parked over the pavement surface and a second water film depth on the pavement surface without a vehicle parked over the pavement surface. The adjusted pavement condition can be calculated based on the delta parameter ΔWFD.

In addition, the pavement condition adjusting module 305 can determine a presence of a curb on the lane based on map data, and the delta parameter, the first water film depth, the second water film depth, or a combination thereof can be further based on the presence of the curb. For example, some lanes with parked vehicle(s) could have a higher WFD due to fact that it is by the curb. The WFD parameter can help to determine if a curb is present. As another example, lanes with parked vehicle(s) can have a lower WFD due to the fact that is closer to drainage. By analogy, the WFD parameter can help to determine if a drainage is present.

In another embodiment, the adjusted pavement condition can be calculated using a machine learning model trained on historical parking data and historical weather data (e.g., as discussed in conjunction with FIG. 2C). As discussed, individual machine learning models could be used for one road weather parameter (e.g., such as intensity of precipitation (IP), pavement temperature (PT), water film depth (WFD), etc.), or a single machine learning model can handle multiple road weather parameters and produces one or more outputs of pavement condition differences contributed by the road weather parameters.

In another embodiment, the map-matching module 303 can determine, based on the map data, at least one object (e.g., buildings, overpasses, etc.) located substantially nearby the road segment (e.g., the road segment 102), and the adjusted pavement condition can account for a reduction of a weather effect on a pavement condition of the lane caused by the at least one object.

Referring back to the diagram 240 of FIG. 2B, the pavement condition adjusting module 305 can consider a snow built-up difference Δwind attributed to building(s) interaction with the wind speed parameter (e.g., blocking snow from building up within the object projection portion 243), such that the refined adjusted pavement condition becomes Δsnow−Δwind. Concurrently or alternatively, the pavement condition adjusting module 305 can further consider a snow melting difference Δsun attributed to building(s) interaction with the sun parameter (e.g., blocking snow from reaching the object projection portion 243), and the adjusted pavement condition becomes Δsnow−Δwind+Δsun.

In one embodiment, in step 405, the output module 307 can provide the adjusted pavement condition of the lane as an output. FIGS. 5A-5C are diagrams of example map user interfaces associated with estimating lane pavement conditions based on street parking events, according to example embodiment(s).

In another embodiment, the data processing module 301 can determine vehicle routing based on the adjusted pavement condition, and the output module 307 can provide the vehicle routing as an output.

In yet another embodiment, the data processing module 301 can determine instructions to a vehicle to park or de-park on the lane based on the adjusted pavement condition, and the output module 307 can provide the instructions as an output.

In yet another embodiment, the output module 307 working in conjunction with the map-matching module 303 can generate a parked location map layer based at least on the parked location data, to support vehicle navigation, first responders, road maintenance, fleet management, etc.

Referring to FIG. 5A, in one embodiment, the system 100 can generate a user interface (UI) 501 (e.g., via the mapping platform 107) for a UE 115 (e.g., a mobile device, a smartphone, a client terminal, etc.) that can allow a user (e.g., a mapping service provider staff, a first responder, a road service provider staff, a vehicle fleet operator staff, an end user, etc.) to see hazard events currently and/or over time (e.g., an hour, a day, a week, a month, a year, etc.) in an area presented over a map 503. Upon selection of one or more of the hazard/snow condition options 505, the user can access the data based on the respective option(s). For instance, the hazard/snow condition options 505 includes a parked location lane option 505a, a plowed option 505b, and a snow-covered option 505c. The parked location lane option 505a allows the user to view parked location lanes determined as discussed. The plowed option 505b allows the user to view plowed roads determined based on known methods. The snow-covered option 505c allows the user to view snow-covered roads determined based on known methods.

In addition, the user can select a “First Responder” button 507 to show current or historical first responding event data in the map 503, or a “Road Maintenance” button 509 to proceed with road maintenance functions with respect to different hazard event(s).

FIG. 5B is a diagram of an example user interface (UI) 511 capable of routing based on pavement condition(s), according to example embodiment(s). In this example, the UI 511 shown is generated for a UE 115 (e.g., a mobile device, an embedded navigation system of a vehicle 101, a client terminal, etc.) that includes a map 513. The UI 511 also presents an option of “navigation” 515 in FIG. 5B for a user to select and plan an optimal route. For instance, the system 100 can decide a fastest route 517 form a current user location 519 to a destination 521. However, the system 100 also determines based on weather information that the fastest route 517 includes mostly snow-covered road segments. In this case, the system 100 presents an notification 523 of “Warning! Snow-covered route.” The system 100 can prompt the user to select a “Reroute” button 525 in response to the notification. Accordingly, when the user selects the “Reroute” button 525, the system 100 can present an alternate route 527 based on the parked location information to ensure the user will pass more parked locations with less snow on the pavements.

In one instance, the UI 511 could also be presented via a headset, goggle, or eyeglass device used separately or in connection with a UE 115 (e.g., a mobile device). In one embodiment, the system 100 can present or surface the parked location information (e.g., connected into one or more snow-free lanes), map data, traffic report data, etc. in multiple interfaces simultaneously (e.g., presenting a 2D map, a 3D map, an augmented reality view, a virtual reality display, or a combination thereof). In one embodiment, the system 100 could also present the parked location information to the user through other media including but not limited to one or more sounds, haptic feedback, touch, or other sensory interfaces. For example, the system 100 could present the parked location information through the speakers of a vehicle 101 carrying the user.

In FIG. 5C, the system 100 may provide interactive user interfaces (e.g., of UE 115 associated with the vehicle 101) for reporting parked and/or available on-street parking locations within parking applications (e.g., INRIX® Parking, Parkopedia®, ParkNow®, etc.). In one scenario, a user interface (UI) 531 of the vehicle 101 depicts a snow-free lane diagram, and prompts the user with a popup 533: “Confirm snow-free spots on a time-restricted parking lane?” An operator and/or a passenger of the vehicle 101 can select a “yes” button 535 or a “no” button 537 based on the user's observation of snow-free spots 539 on a time-restricted parking lane.

For example, the user interface can present the UI 531 and/or a physical controller such as but not limited to an interface that enables voice commands, a pressure sensor on a screen or window whose intensity reflects the movement of time, an interface that enables gestures/touch interaction, a knob, a joystick, a rollerball or trackball-based interface, or other sensors. As other examples, the sensors can be any type of sensor that can detect a user's gaze, heartrate, sweat rate or perspiration level, eye movement, body movement, or combination thereof, in order to determine a user response to confirm road events. As such, the system 100 can enable a user to confirm snow-free lanes as training data for the machine learning model to train as discussed.

In one embodiment, the vehicles 101 are autonomous vehicles or highly assisted driving vehicles that can sense their environments and navigate within a travel network without driver or occupant input. It is contemplated the vehicle 101 may be any type of transportation wherein a driver is in control of the vehicle's operation (e.g., an airplane, a drone, a train, a ferry, etc.). In one embodiment, the vehicle sensors 103 (e.g., camera sensors, light sensors, LiDAR sensors, radar, infrared sensors, thermal sensors, and the like) acquire map data and/or sensor data during operation of the vehicle 101 within the travel network for routing, historical trajectory data collection, and/or destination prediction.

In one embodiment, one or more user equipment (UE) 115 can be associated with the vehicles 101 (e.g., an embedded navigation system) a person or thing traveling within the travel network. By way of example, the UEs 115 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that the UEs 115 can support any type of interface to the user (such as “wearable” circuitry, etc.). In one embodiment, the vehicles 101 may have cellular or wireless fidelity (Wi-Fi) connection either through the inbuilt communication equipment or from the UEs 115 associated with the vehicles 101. Also, the UEs 115 may be configured to access the communication network 109 by way of any known or still developing communication protocols.

In one embodiment, the UEs 115 include a user interface element configured to receive a user input (e.g., a knob, a joystick, a rollerball or trackball-based interface, a touch screen, etc.). In one embodiment, the user interface element could also include a pressure sensor on a screen or a window (e.g., a windshield of a vehicle 101, a heads-up display, etc.), an interface element that enables gestures/touch interaction by a user, an interface element that enables voice commands by a user, or a combination thereof. In one embodiment, the UEs 115 may be configured with various sensors 117 for collecting passenger sensor data and/or context data during operation of the vehicle 101 along one or more roads within the travel network. By way of example, the sensors 117 are any type of sensor that can detect a passenger's gaze, heartrate, sweat rate or perspiration level, eye movement, body movement, or combination thereof, in order to determine a passenger context or a response to output data. In one embodiment, the UEs 115 may be installed with various applications 119 to support the system 100.

In one embodiment, the mapping platform 107 has connectivity over the communication network 109 to the services platform 121 that provides the services 123. By way of example, the services 123 may also be other third-party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc.

In one embodiment, the content providers 125 may provide content or data (e.g., including geographic data, output data, historical trajectory data, etc.). The content provided may be any type of content, such as map content, output data, audio content, video content, image content, etc. In one embodiment, the content providers 125 may also store content associated with the weather event/road link correlation data, the geographic database 111, mapping platform 107, services platform 121, services 123, and/or vehicles 101. In another embodiment, the content providers 125 may manage access to a central repository of data, and offer a consistent, standard interface to data, such as a repository of weather event/road link correlation data and/or the geographic database 111.

By way of example, as previously stated the vehicle sensors 103 may be any type of sensor. In certain embodiments, the vehicle sensors 103 may include, for example, a global positioning sensor for gathering location data, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., for detecting objects proximate to the vehicle 101), an audio recorder for gathering audio data (e.g., detecting nearby humans or animals via acoustic signatures such as voices or animal noises), velocity sensors, and the like. In another embodiment, the vehicle sensors 103 may include sensors (such as LiDAR, Radar, Ultrasonic, Infrared, cameras (e.g., for visual ranging), etc. mounted along a perimeter of the vehicle 101) to detect the relative distance of the vehicle 101 from lanes or roadways, the presence of other vehicles, pedestrians, animals, traffic lights, road features (e.g., curves) and any other objects, or a combination thereof. In one scenario, the vehicle sensors 103 may detect weather data, traffic information, or a combination thereof. In one example embodiment, the vehicles 101 may include GPS receivers to obtain geographic coordinates from satellites 127 for determining current location and time. Further, the location can be determined by a triangulation system such as A-GPS, Cell of Origin, or other location extrapolation technologies when cellular or network signals are available. In another example embodiment, the one or more vehicle sensors 103 may provide in-vehicle navigation services.

The communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 5G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the mapping platform 107 may be a platform with multiple interconnected components. By way of example, the mapping platform 107 may include multiple servers, intelligent networking devices, computing devices, components, and corresponding software for determining upcoming vehicle events for one or more locations based, at least in part, on signage information. In addition, it is noted that the mapping platform 107 may be a separate entity of the system 100, a part of the services platform 121, the one or more services 123, or the content providers 125.

By way of example, the vehicles 101, the UEs 115, the mapping platform 107, the services platform 121, and the content providers 125 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

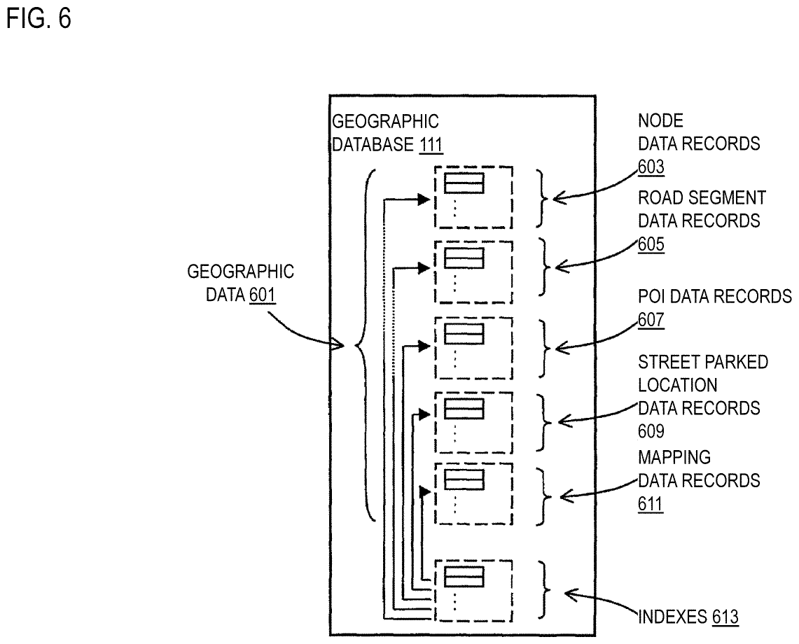

FIG. 6 is a diagram of a geographic database (such as the database 111), according to one embodiment. In one embodiment, the geographic database 111 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 111 include high resolution or high definition (HD) mapping data that provide centimeter-level or better accuracy of map features. For example, the geographic database 111 can be based on Light Detection and Ranging (LiDAR) or equivalent technology to collect billions of 3D points and model road surfaces and other map features down to the number lanes and their widths. In one embodiment, the mapping data (e.g., mapping data records 611) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 111.

“Node”— A point that terminates a link.

“Line segment”— A straight line connecting two points.

“Link” (or “edge”)— A contiguous, non-branching string of one or more line segments terminating in a node at each end.

“Shape point”— A point along a link between two nodes (e.g., used to alter a shape of the link without defining new nodes).

“Oriented link”— A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 111 follows certain conventions. For example, links do not cross themselves and do not cross each other except at a node. Also, there are no duplicated shape points, nodes, or links. Two links that connect each other have a common node. In the geographic database 111, overlapping geographic features are represented by overlapping polygons. When polygons overlap, the boundary of one polygon crosses the boundary of the other polygon. In the geographic database 111, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 111 includes node data records 603, road segment or link data records 605, POI data records 607, street parked location data records 609, mapping data records 611, and indexes 613, for example. More, fewer or different data records can be provided. In one embodiment, additional data records (not shown) can include cartographic (“carto”) data records, routing data, and maneuver data. In one embodiment, the indexes 613 may improve the speed of data retrieval operations in the geographic database 111. In one embodiment, the indexes 613 may be used to quickly locate data without having to search every row in the geographic database 111 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points (such as intersections) corresponding to the respective links or segments of the road segment data records 605. The road link data records 605 and the node data records 603 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 607. The geographic database 111 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city). In one embodiment, certain attributes, such as lane marking data records, mapping data records and/or other attributes can be features or layers associated with the link-node structure of the database.

In one embodiment, the geographic database 111 can also include street parked location data records 609 for storing street parked location data, pavement condition difference data, training data, prediction models, annotated observations, computed featured distributions, sampling probabilities, and/or any other data generated or used by the system 100 according to the various embodiments described herein. By way of example, the street parked location data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the mapping data records 611 model road surfaces and other map features to centimeter-level or better accuracy. The mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 611 are divided into spatial partitions of varying sizes to provide mapping data to vehicles 101 and other end user devices with near real-time speed without overloading the available resources of the vehicles 101 and/or devices (e.g., computational, memory, bandwidth, etc. resources).

In one embodiment, the mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 611.

In one embodiment, the mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 111 can be maintained by the content provider 121 in association with the services platform 121 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle (e.g., vehicles 101 and/or user terminals 115) along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or a user terminal 109, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for estimating lane pavement conditions based on street parking events may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

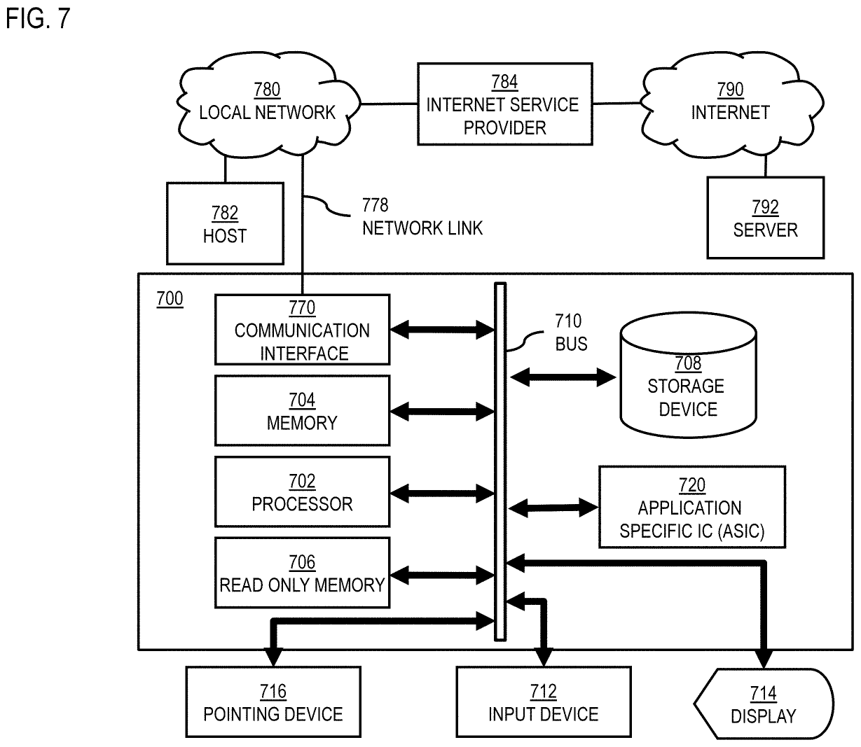

FIG. 7 illustrates a computer system 700 upon which an embodiment of the invention may be implemented. Computer system 700 is programmed (e.g., via computer program code or instructions) to estimate lane pavement conditions based on street parking events as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to estimating lane pavement conditions based on street parking events. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RANI) or other dynamic storage device, stores information including processor instructions for estimating lane pavement conditions based on street parking events. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for estimating lane pavement conditions based on street parking events, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 109 for estimating lane pavement conditions based on street parking events.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

FIG. 8 illustrates a chip set 800 upon which an embodiment of the invention may be implemented. Chip set 800 is programmed to estimate lane pavement conditions based on street parking events as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to estimate lane pavement conditions based on street parking events. The memory 805 also stores the data associated with or generated by the execution of the inventive steps.

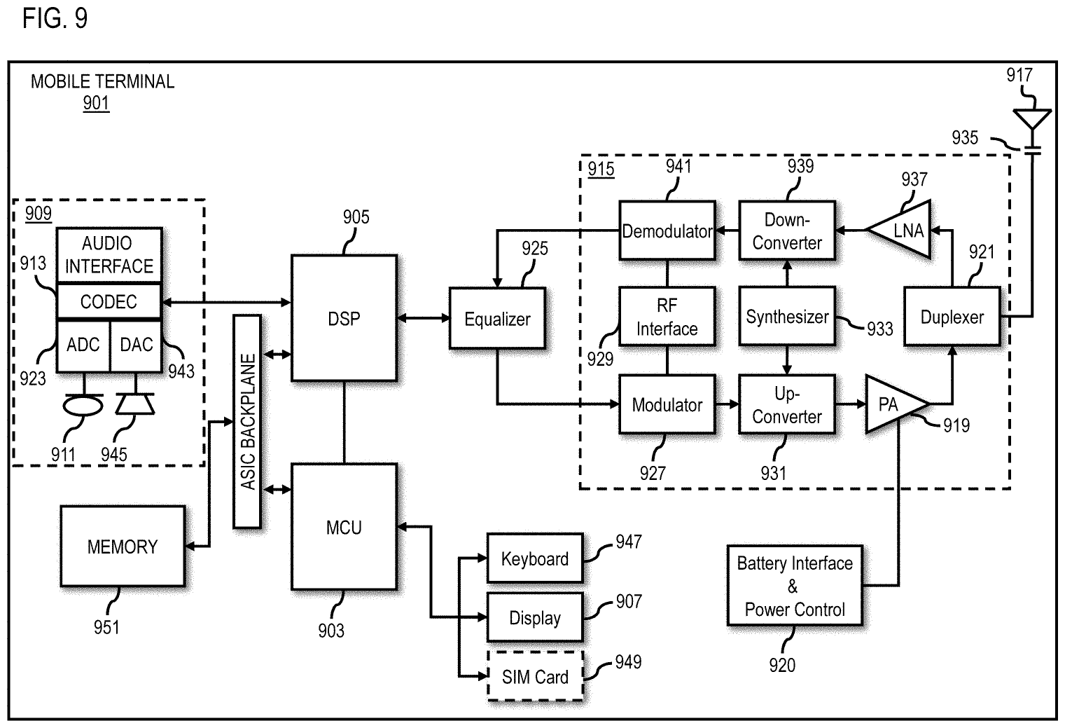

FIG. 9 is a diagram of exemplary components of a mobile terminal 901 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to estimate lane pavement conditions based on street parking events. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
map-matching a vehicle park-in event, a vehicle park-out event, or a combination thereof to a lane of a road segment;
calculating an adjusted pavement condition of the lane based on the map-matched park-in event, the map-matched park-out event, or a combination thereof, wherein the adjusted pavement condition accounts for a reduction of a weather effect on a pavement condition of the lane caused by one or more vehicles parking in the lane; and
providing the adjusted pavement condition of the lane as an output.

2. The method of claim 1, wherein the weather effect is an intensity of precipitation, and wherein the adjusted pavement condition or the pavement condition relates to a slippery road driving condition caused by the intensity of precipitation.

3. The method of claim 2, further comprising:
determining a delta parameter for the intensity of precipitation based on a difference between a first amount of precipitation reaching a pavement surface of the lane with a vehicle parked over the pavement surface and a second amount of precipitation reaching the pavement surface without a vehicle parked over the pavement surface,
wherein the adjusted pavement condition is calculated based on the delta parameter.

4. The method of claim 1, wherein the adjusted pavement condition or the pavement condition relates to a pavement temperature.

5. The method of claim 4, further comprising:
determining a delta parameter for the pavement temperature based on a difference between a first pavement temperature of a pavement surface of the lane with a vehicle parked over the pavement surface and a second pavement temperature of the pavement surface without a vehicle parked over the pavement surface,
wherein the adjusted pavement condition is calculated based on the delta parameter.

6. The method of claim 1, wherein the weather effect is a water film depth, and wherein the adjusted pavement condition or the pavement condition relates to a slippery road driving condition caused by the intensity of precipitation.

7. The method of claim 6, further comprising:
determining a delta parameter for the water film depth based on a difference between a first water film depth on a pavement surface of the lane with a vehicle parked over the pavement surface and a second water film depth on the pavement surface without a vehicle parked over the pavement surface,
wherein the adjusted pavement condition is calculated based on the delta parameter.

8. The method of claim 6, further comprising:
determining a presence of a curb adjacent to the lane based on map data,
wherein the delta parameter, the first water film depth, the second water film depth, or a combination thereof is further based on the presence of the curb.

9. The method of claim 1, wherein the adjusted pavement condition is calculated using a machine learning model trained on historical parking data and historical weather data.

10. The method of claim 1, further comprising:
determining vehicle routing based on the adjusted pavement condition.

11. The method of claim 1, further comprising:
transmitting instructions to a vehicle to park or de-park on the lane based on the adjusted pavement condition.

12. The method of claim 1, wherein the vehicle park-in event, the vehicle park-out event, or a combination thereof is detected using one or more sensors.

13. The method of claim 1, further comprising:
determining, based on map data, at least one object located substantially nearby the road segment,
wherein the adjusted pavement condition accounts for a reduction of a weather effect on a pavement condition of the lane caused by the at least one object.

14. An apparatus comprising:
at least one processor; and
at least one memory including computer program code for one or more programs,
the at least one memory and the computer program code configured to, with the at least one processor, cause the apparatus to perform at least the following,
map-match a vehicle park-in event, a vehicle park-out event, or a combination thereof to a lane of a road segment;
calculate an adjusted pavement condition of the lane based on the map-matched park-in event, the map-matched park-out event, or a combination thereof, wherein the adjusted pavement condition accounts for a reduction of a weather effect on a pavement condition of the lane caused by one or more vehicles parking in the lane; and
provide the adjusted pavement condition of the lane as an output.

15. The apparatus of claim 14, wherein the adjusted pavement condition or the pavement condition relates to at least one road weather parameter, and the apparatus is further caused to:
determine a delta value for the at least one road weather parameter based on a difference between a first value of a pavement surface of the lane with a vehicle parked over the pavement surface and a second value of the pavement surface without a vehicle parked over the pavement surface,
wherein the adjusted pavement condition is calculated based on the delta value.

16. The apparatus of claim 15, wherein the at least one road weather parameter is an intensity of precipitation, a pavement temperature, or a water film depth.

17. The apparatus of claim 14, wherein the adjusted pavement condition is calculated using a machine learning model trained on historical parking data and historical weather data

18. A non-transitory computer-readable storage medium carrying one or more sequences of one or more instructions which, when executed by one or more processors, cause an apparatus to perform:
map-matching a vehicle park-in event, a vehicle park-out event, or a combination thereof to a lane of a road segment;
calculating an adjusted pavement condition of the lane based on the map-matched park-in event, the map-matched park-out event, or a combination thereof, wherein the adjusted pavement condition accounts for a reduction of a weather effect on a pavement condition of the lane caused by one or more vehicles parking in the lane; and
providing the adjusted pavement condition of the lane as an output.

19. The non-transitory computer-readable storage medium of claim 18, wherein the adjusted pavement condition or the pavement condition relates to at least one road weather parameter, and the apparatus is further caused to perform:
determining a delta value for the at least one road weather parameter based on a difference between a first value of a pavement surface of the lane with a vehicle parked over the pavement surface and a second value of the pavement surface without a vehicle parked over the pavement surface,
wherein the adjusted pavement condition is calculated based on the delta value.

20. The non-transitory computer-readable storage medium of claim 19, wherein the at least one road weather parameter is an intensity of precipitation, a pavement temperature, or a water film depth.
